(19) United States
(12) Patent Application Publication
(10) Pub. No.: US 2009/0158185 A1
(43) Pub. Date: Jun. 18, 2009

(54) Adaptive map layer visibility control

(75) Inventors: Ahmed Lacevic, Woodside, NY (US); Andrew Beveridge, Bronxville, NY (US)

Correspondence Address: Bressler, Amery & Ross, P.C., 17 State Street, New York, NY, 10004, US

(73) Assignee: SocialExplorer, Inc.

(21) Appl. No.: 12/002,499

(22) Filed: Dec. 17, 2007

(51) Int. Cl. G06F 3/14

(52) U.S. Cl. 715/768

(57) ABSTRACT

The instant application provides a method and related system that adaptively turns layers on and off based upon a visibility value extracted from a respective layer or related database. Map data is first portioned by a grid and the visibility value for a layer is computed for each grid element. For a given map view, the visibility value of all grid elements within the view is used to compute an overall average visibility value for the layer in the current map view. The layer is then activated based upon the average visibility value as compared to a table of optimal scales.

### STATEMENT REGARDING FEDERALLY FUNDED RESEARCH

The research leading to the present invention was supported in part by National Science Foundation Grant No. 0226279. Accordingly, the U.S. Government may have certain rights in this invention.

### FIELD OF THE INVENTION

The present invention relates generally to mapping methods and systems. More particularly, the present invention discloses a method and related system that adaptively controls the display of one or more layers on a map.

### BACKGROUND OF THE INVENTION

Vector based maps are usually composed of multiple geographic vector layers. Each layer of the map provides geographic information, such as country boundaries, state boundaries, city locations, roads, geographic features and other geographical information. The display of these layers is controlled by a respective style, which may include line color, thickness and visibility, and which also indicates the scale at which the respective layer becomes visible and when the layer disappears from view.

For readability, not all layers can be visible at all scales. The reason for this is that a high density layer (that is, a layer with a lot of features) at small scales would densely cover the map and hence little else would be visible. Good map design requires a balance between providing valuable information and showing too much information at one time. The control of layer visibility becomes particularly important for interactive systems where the user is free to change the scale of the view at any given time, and for online systems where the scale is further used to control how fast the map renders by limiting the number of features and layers visible at any one time to a set that performs fast and that is informative to the user.

The conventional method for controlling layer visibility is to turn layers on at a particular scale, and turn them off at another scale. That is, a layer may only be visible (i.e., turned on) when the scale at which the map is being viewed is between two values, and invisible (i.e., turned off) otherwise. For example, an interactive mapping system may turn on county outlines at a scale where the county outlines will not take up a significant portion of the visual display; that is, at a scale where the display area occupied by the county lines is not a significant fraction (say 5 to 10 percent depending on the other features in the area.) of the total display area. A scale of 1:4,000,000 (63 miles per inch) may be found to be suitable, for example. On the other hand, census tracts are much smaller and therefore the scale would need to be much larger, such as 1:130,000 (2 miles per inch) to avoid the clutter that would otherwise result at smaller scales.

The scale of an interactive map changes all the time as the user zooms and pans around the map. The scale may range, for example, from the view of the entire world to a small area such as a street block or smaller. Different regions within a map or map database may have different geographical densities for a particular layer. Setting layer visibility using a single map scale value may thus provide visually satisfactory results for some regions but not for others. The New York City area and the state of Wyoming provide examples of such geographic density variations. Displaying census tract outlines at the suggested scale of 2 miles per inch may work fine for New York City, but at that scale a user would have a very hard time locating tracts in the state of Wyoming. The reason for this is that census tracts in Wyoming are very large, since the population density is very small (only 5 people per square mile on average), while those in New York City are very small geographically, since the population is so much more dense. The disparity between these two regions is so great that any attempt at bridging them would result in at least one of the regions not displaying optimally. The same is true of roads and other common geographical features. Reference is drawn to FIGS. 1 and 2. In both figures, zip codes are displayed at the same scale of 1:3,800,000 (about 30 miles per inch). FIG. 1 shows zip codes in the state of Wyoming. The zip code boundaries in FIG. 1 are clearly visible, including their respective labels. In FIG. 2, however, which is displayed at the same scale as that used in FIG. 1, and which shows New York City and surrounding areas, many of the zip code labels are illegible; similarly, many of the zip code boundary lines are indistinguishable from each other. Despite the fact that the same scale is used in both maps, features (i.e., zip code boundaries) easily visible in one region of a map (FIG. 1) may be illegible in another region (FIG. 2).

Accordingly, there is an immediate need for improved methods and systems for interactively displaying map data.

### SUMMARY OF THE INVENTION

The various disclosed embodiments overcome the drawbacks of the prior art. A preferred embodiment method controls visibility of a layer on a display, in which the layer corresponds to a set of features to be displayed from feature data. A preferred embodiment method comprises determining a visibility value from data in the current map view on the display, and then turning the layer on or off according to the visibility value and optionally the scale of the current view. In various embodiments, the visibility value is an average density of features or data in the current view. In certain preferred embodiments, when the density is computed from features, it is the features in the layer that are used to compute the density value. In other preferred embodiments, when data is used, the data is obtained from population information so that a population density is computed, which is often closely related to geographic feature density.

In certain preferred embodiments, determining the average density of features in the current view comprises defining a grid that is formed from a plurality of grid elements. The feature data is used to determine a respective density of features within each of the grid elements. Subsequently, when updating the display, grid elements that are at least partially visible within the current view are determined. Then, the corresponding feature densities of these at least partially visible grid elements are used to determine the average density of the features in the current view.

In specific embodiments, determining the density of features in the grid elements comprises determining the number of features within each grid element as a feature count, and dividing the feature count by a corresponding area of the grid element. In yet a further specific embodiment, each grid element may be clipped to other feature data, and it is the area of the clipped grid element that is used when computing the corresponding feature density of the grid element.

In various embodiments, turning the layer on or off according to the visibility value includes utilizing the visibility value to test against a predetermined threshold value or a range of values. If the visibility value is within the range, the layer would be visible otherwise it would be invisible.

In various embodiments, turning the layer on or off according to the visibility value includes utilizing the visibility value to obtain a corresponding optimal scale, and then turning the layer on if the scale of the current map view is greater than the corresponding optimal scale. In certain embodiments, a set of optimal scales may be provided that associates a plurality of visibility values or visibility value ranges with a corresponding plurality of optimal scale values or scale value ranges. The visibility value may then be used to select the corresponding scale value that is then used as the corresponding optimal scale.

Another aspect provides a computer system that controls the display of layers based upon the visibility values of the layers. The computer system includes a central processing unit (CPU), a display, and memory. The memory includes a database that defines a map displayable as a plurality of layers, wherein each layer corresponds to a set of features in the map. The memory also includes program code that, when executed by the CPU, causes the CPU to perform standard mapping functions that utilize the database to present maps on the display. In addition, however, the program code also causes the CPU to control the visibility of the layers according to one or more of the invention methods.

### BRIEF DESCRIPTION OF THE DRAWINGS

FIG. 1 is a map showing zip codes and related boundaries in the state of Wyoming at a scale of 1:3,800,000.

FIG. 2 is a map showing zip codes and related boundaries in New York City and surrounding areas at a scale of 1:3,800,000.

FIG. 3 indicates a mapping system that may employ any one or more of the various embodiment methods.

FIG. 4 shows a current map view with a certain scale near a first sub-region.

FIG. 5 shows a current map view with a scale identical to that of FIG. 4, but panned to a second sub-region.

FIGS. 6 to 10 are illustrations of a 10 10 mile grid for successively larger-scaled maps.

FIG. 11 shows a continental U.S. population density map on a 10 10 mile grid.

FIG. 12 illustrates the selection of grid elements for subsequent density calculations.

FIG. 13 provides a detailed view of a region within a map view

FIG. 14 provides a larger view of the view shown in FIG. 13.

FIG. 15 shows a user interface for providing a set of scales that is used to control the visibility of a layer.

FIG. 16 shows a user interface that enables a user to choose if the visibility of a layer is to be conditional upon a visibility value associated with the layer.

FIG. 17 shows a current view of a map region with overlaid street features and visibility grid.

FIG. 18 is a screen shot showing the association of street lengths with grid elements to provide a visibility value to each grid element.

FIGS. 19A & 19B illustrate the visibility values of grid elements varying as a function of the lengths of streets.

FIG. 20 illustrates utilizing weighted averages when computing a final visibility value.

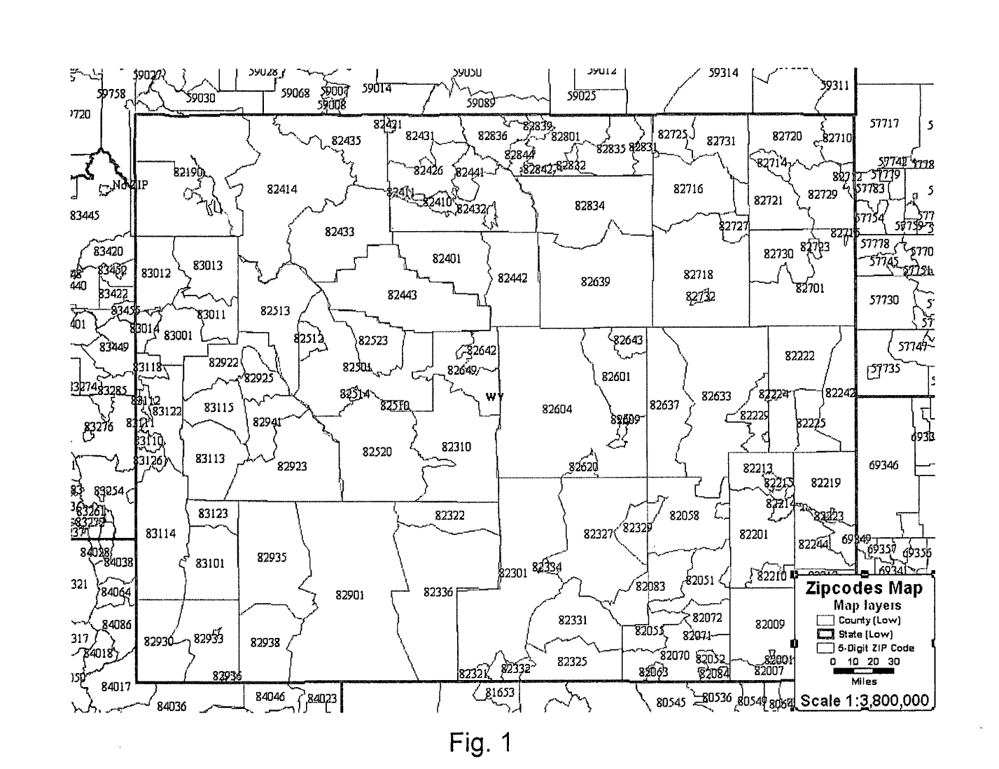

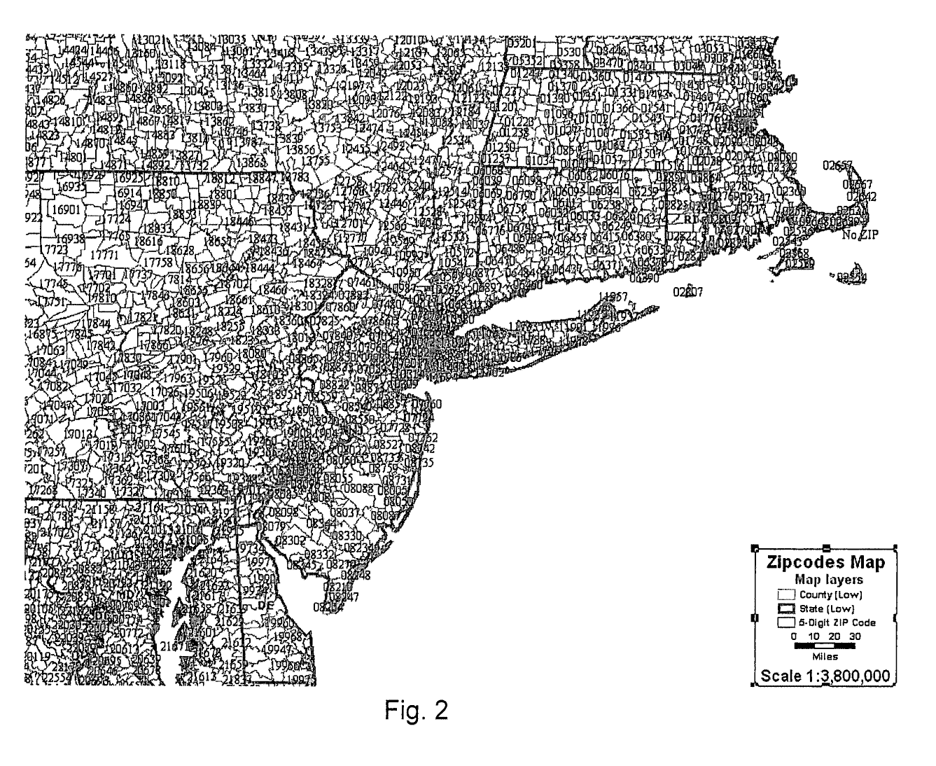

### DETAILED DESCRIPTION

Various non-limiting embodiments disclosed herein disclose methods and related systems that provide adaptive scaling to allow map designers or users of interactive mapping systems to control the scale at which a layer will be turned on or turned off based upon a visibility value computed from data within the area being viewed. If, for example, the user is looking at Wyoming, one set of optimal scales would apply, whereas another set of optimal scales would apply for New York City. As a result, the map view is optimized for the region being viewed.

In various embodiments, a visibility value is used to determine when a layer is turned on or off. The visibility value may be computed, for example, using either geographic density (such as features per unit area), population density (object instances per unit area), an absolute count value of the features present in the current view, or any other suitable function of features or data present within the current view. Therefore, layers would be shown at different scales for different regions of the country, based on the visibility value computed for the view. So, for areas with high population/geographic densities, layers can be shown at large scales, whereas for areas with low population/geographic densities, layers are shown at smaller scales.

In the following disclosure various terms are used, which may be beneficially defined to provide a better understanding of the various embodiments. These definitions are intended to be illustrative, and should not be construed as limiting.

A “feature” or “geographical feature” is a logical object that can be displayed on a map. Common features include roads, political boundaries, administrative boundaries, isolines (as for altitude, distributions and the like), land masses, waterways, bodies of water, etc. A feature typically means one geographic record within a map layer. So, a single census tract would be a feature of a tract layer in a map. A census tract layer could have over 65,000 features (in, for example, census data taken for the year 2000), one feature for each census tract. A feature may be composed of one or more vertices.

A “layer” is a set of one or more features that a user may wish displayed, and includes the geographic information needed to draw the one or more features. This geographic information may include, for example, vector information used to define and draw the visual extents or vertices of the feature on the map, as known in the art. This geographic information may also include position information used to define the geographic location at which a feature is present. A layer may broadly include an entire class of something, or may specifically include only a sub-class. For example, a layer may include all vehicle-navigable roads. Alternatively, another layer may include only those roads having four or more lanes. Indeed, a layer may include a broad array of features that appear to be unrelated to each other, but which together have significance to the user. Layers usually contain features of the same type. These types are usually either points, lines, or polygons. A map may be comprised of one or more layers. Layers with differing types may be mixed within the same map. A user may determine which sets of features he or she desires to see, and instruct the corresponding layer or layers to be turned on and thus be visible on the map if in view. If a layer has one or more features, then all features in that layer are displayed when the layer is turned on and the features are within the map view. Alternatively, a layer may be setup to display, for example, a feature or features in only a certain predefined region or regions. Vector information in the layers is typically drawn as lines, points or polygons. Optionally, associated text may be drawn as well. The feature types and text in a layer are drawn according to a style associated with that layer. For example, a layer corresponding to waterways may be drawn in blue, together with the text naming the waterways, whereas a layer associated with roads may be drawn in red. Text color and line color need not be identical. The drawing style of a layer, such a line thickness, line style (dotted, dashed, etc.), line color, text height, text color, etc., may be set by the user, may be predetermined, computed on the fly as a function of another parameter, such as scale, or a combination thereof.

A “scale” of a map determines the displayed size of the features, as known in the art. That is, when converting the world coordinates of a feature into display coordinates, the scale determines how large or how small individual aspects of a feature will appear on the display. The larger the scale, the larger the features appear when displayed on the map. Hence, features that extend across large geographic distances may be readily visible at small scales, whereas features that extend only across small distances will be visible only for large scales. Generally, as the scale is decreased, the visual density of a layer will increase per unit area on the display.

A “display” is any object that may be controlled to present a map. It will usually be a video display, but may also include, for example, a printer, plotter or a projector. A “current view” of the display is the map presented on the display, and is a function of the pan and scale as selected, for example, by a user. As known in the art, world coordinates as used by features in the map may be translated into display coordinates for presentation of those features on the display in the current view. Similarly, display coordinates in the current view may be translated into world coordinates. Both pan and scale are typically used for such translations.

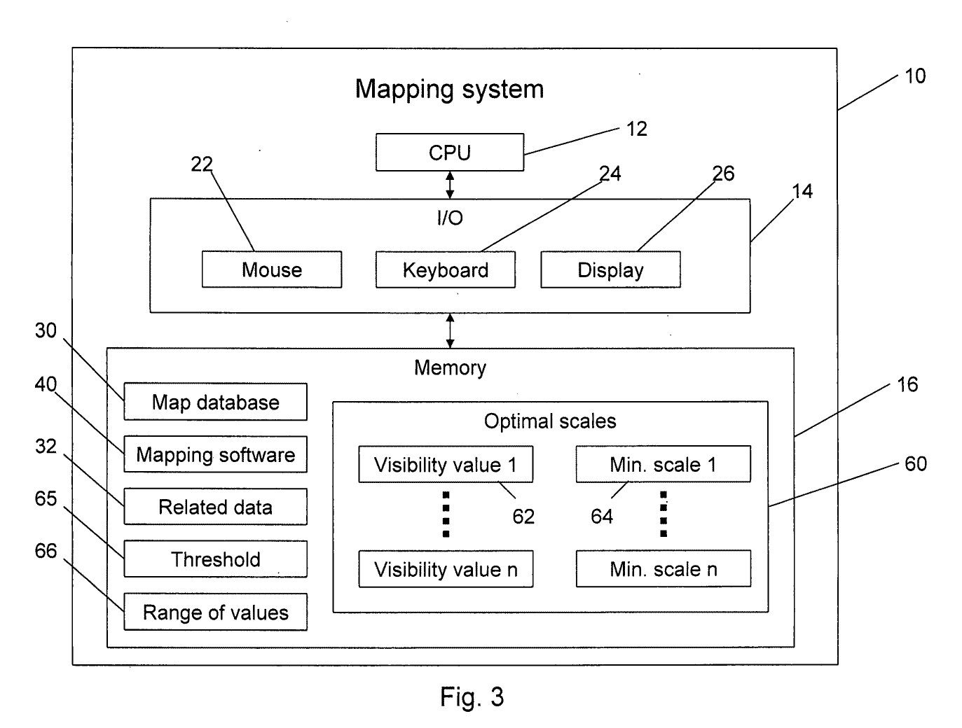

FIG. 3 indicates a typical mapping system 10 which may employ any one or more of the various embodiment methods. The mapping system 10 comprises a central processing unit (CPU) 12, input/output devices 14 and memory 16. The CPU 12 performs steps necessary to obtain the desired mapping functionality, and can accept input from the I/O devices 14 as well as control output provided by the I/O devices 14. The I/O devices 14 may include, for example, a mouse or similar pointing device 22, a keyboard 24 and a display 26. The CPU 12 presents maps to the user on display 26, and accepts input from at least the mouse 22 and keyboard 24 to change the map being displayed. The memory 16 includes mapping software 40 executable by the CPU 12 to cause the CPU 12 to perform an embodiment mapping method. The mapping software 40 utilizes a map database 30, which contains information needed to generate a desired map. Map database 30 will typically cover, or encode, all features within a predetermined region, such as the United States. Apart from the mapping software 40, mapping system 10 may be conventional in nature.

It should be appreciated that the mapping system 10 need not be a single, contiguous device. Instead, as known in the art, the mapping system 10 may be a distributed system. For example, in preferred embodiments the mapping system 10 may employ a client-server architecture, in which portions of the system 10 are on the client side, such as the display 26, keyboard 24 and mouse 22, while other portions of the system 10 are on the server side, such as map database 30. A detailed description of such distributed systems and the plethora of related embodiments thereto is beyond the scope of this disclosure. However, designing and coding for such systems is well developed, and providing such a system that employs the claimed methods disclosed herein should be well within the means of one having ordinary skill in the relevant art after having the benefits of the instant disclosure.

Mapping software 40 may contain all, or portions of, the steps conventionally known to render a map from the map database 30. Such conventional steps may include, for example, those employed to extract world-coordinate data from the map database 30, parsing this data and converting at least a subset of it into corresponding display coordinates, rendering the display coordinates to the display 26, and accepting user input from the I/O devices to change the pan and scale of the map so rendered. With particular respect to vector-based maps, the mapping software 40 may further include those steps that permit the user to select desired features, associate these features with a layer, and to render the map based upon which layers are turned on and which are turned off. Of course, predefined layers are also possible. In addition, however, the mapping software 40 includes embodiment steps discussed below that are used to control whether the features in a layer are turned on or off—i.e., to control the visual state of the features in the layer.

The steps performed by various embodiments of the mapping software 40 to control the visual state of the features in each layer may include calculating a visibility value based upon features within the current view or data mappable to the current view, and then using the visibility value and optionally the current scale to determine if a layer features should be visible. In one embodiment, for example, the visibility of layer features is controlled based simply on the comparison of a final visibility value to a threshold value or a defined range of values. When the final visibility value falls within the specified range the layer is visible. The final visibility value may be a function, for example, of the number of features in the current view, the density of features in the current view, or any other suitable function. For example, if the feature density is between 0 and 100 items per square mile, the features in the layer are made visible, otherwise they are made invisible. In other embodiments, the number of features in a current view is counted and used as the final visibility value for the current view, which may then be similarly used to control the visibility of layer features. Alternatively, an optimal scale value may be selected or computed based upon the final visibility value. The visibility of a layer may then be controlled based upon a comparison of the optimal scale value with the scale used for the current view. For example, if the optimal scale value is larger than the scale of the current view, then the layer features are turned off; otherwise, the layer features would be turned on.

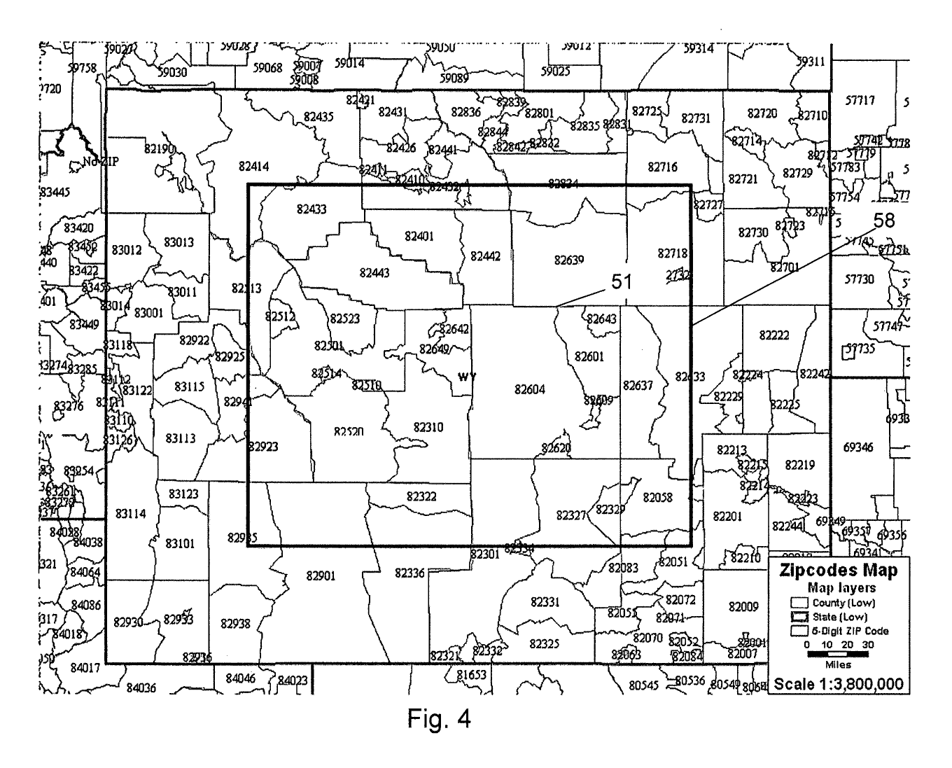

By way of example, consider the situation in which the map database 30 encodes layers and corresponding features for a region that includes the continental United States. Further assume that the user has panned the current view to a point within the state of Wyoming, and has set the scale of the current view to 1:3,800,000. This situation is illustrated in FIG. 4, in which rectangle 58 represents the current view as shown on the display 26. Zip code features 51 are encoded in map database 30, and may be logically associated with a corresponding zip code layer. The zip code layer may also include the labels, or text, associated with each zip code feature 51. Zip code features 51 are used by way of example, but it should be understood that any type of feature may be used, such as roads, census boundaries, buildings, etc. Map database 30 will typically include other features in addition to the zip code features 51, although this is not required. Code in mapping software 40 causes the CPU 12 to count all of the zip code features 51 in map database 30 (i.e., all the features in the zip code layer) that are within the current view 58. This will include all zip code features 51 that are wholly within the current view 58, and may also include all zip code features 51 that are partially within the current view 58. The resultant feature count is used as the final visibility value, which is then used to control the visibility of a layer features associated with the zip code features 51. Such association may be made, for example, by the user indicating such to the mapping software 40 through a suitable user interface, or may be provided pre-programmed into the mapping software 40. A layer associated with the zip code features 51 may be, for example, the zip code layer itself, or another layer, such as a layer for roads. For the sake of simplicity, it is assumed in the following that the layer being controlled is the zip code layer.

In various embodiments, the visibility of layer features may be controlled by comparing the final visibility value to a threshold value 65 or a range of values 66. As indicated above, the final visibility value may be the number of features 51 within current view 58, but other functions for the final visibility value may be used, such as the average density of features 51 within current view 58. If the final visibility value exceeds a threshold value 65, or is outside the range of values 66, the layer associated with the features 51 is set to a first state, which may be turned off. When turned off, the features are not visible in the current view 58; additionally, any labels or text in the layer associated with the features 51 may also be made invisible. If the final visibility value is equal to or below the threshold value 65, or is within the range of values 66, then the layer features associated with the features 51 is set to a second state, which may be turned on. Of course, other functions may be used depending upon how the final visibility value is generated, or what the threshold value 65 represents in relation to the final visibility value. The threshold value 65, or range of values 66, may be predetermined, for example by trial and error by a cartographer and then provided prepackaged with the mapping software 40, may be configurable by the user by way of any suitable user interface provided by the mapping software 40, or combinations thereof.

Any text or labels in the layer associated with the features 51 may also be turned on together with the layers 51, or may be turned on independently in accordance with a second threshold value or value range set specifically for such labels or text. Hence, features in the layer associated with the features 51 may turn on at one scale, and the related text or labels may turn on at a different scale or at the same scale. For the sake of simplicity, in the following, unless noted otherwise, it is assumed that labels or text associated with features in a layer will turn on and off with those features in the layer. Hence, in the embodiments subsequently described, the visibility of the entire layer is controlled, both features and labels, and is discussed accordingly. However, it should be understood that labels and features may be controlled independently of each other.

In certain embodiments, the final visibility value and the scale of the current view are used together to determine if the layer for the zip code features 51 should be turned on or off. For example, for optimal viewing, if the feature count is less than 50, a scale of 1:4,000,000 may be used; if the feature count is between 51 and 100, a scale 1:3,000,000 should be used; if the feature count is between 101 and 500, a scale of 1:2,000,000 should be used, and so on. The optimal scale may be compared to the scale of the current map view 58. If the optimal scale is less than or equal to the scale of the current map view 58, then the layer for the zip code features 51 may be turned on, so that the zip code features 51 are visible in the current view 58. Otherwise, the layer for the zip code features 51 may be turned off.

The optimal scale values may be provided, for example, by a lookup table 60 that may be configured or setup by the user by way of any suitable user interface provided by the mapping software 40. The table of optimal scales 60 may include, for example, a column of visibility values 62 and a related column of minimum scales 64. The final visibility value calculated above may be used to index into the column of visibility values 62 to select a corresponding minimum scale 64 using any method known in the art, such as finding the value 62 closest to the final visibility value, the largest value 62 that the final visibility value is less than or equal to, finding the minimum scale value 64 that lies within a predetermined range of visibility values 62, etc. For the sake of simplicity, only a single visibility value 62 is shown associated with a single minimum scale value 64, but it will be appreciated that other formats for the table 60 are possible. Once obtained from the lookup table 60, the selected minimum scale 64 may then be adopted as the optimal scale and compared against the scale of the current view 58. If the scale of the current view 58 is less than the selected optimal scale 64, then the layer is turned off, otherwise, the layer is turned on. Of course, if labels are to be treated differently from features, then the lookup table 60 may include a column that is similarly used to control the visibility of the labels. Typically, although not required, labels will turn on at the same scale as the features, or at a scale that is somewhat larger than the scale at which the features turn on.

Although a single lookup table 60 may be provided to control the activation of all layers, in preferred embodiments, each layer in the current view 58 will have its own corresponding lookup table 60 that is configured specifically for the optimal viewing of that layer with respect to the calculated final visibility value. Also, it should be understood that a single final visibility value may be calculated for all layers. Alternatively, each layer may have a respective final visibility value calculated based upon features or data particular to that layer. For example, the visibility of a road layer and a zip code layer may both be determined by a single final visibility value calculated based upon the zip code features 51. However, each layer may have its own respective lookup table 60 to obtain the corresponding selected minimum scale 64 (or scales, if labels are to be controlled independently of features). Alternatively, a final visibility value based upon road features may be computed for the road layer, and a separate final visibility value based upon the zip code features 51 may be calculated for the zip code layer. Each final visibility value would be used in the respective lookup table 60 for that layer to select the corresponding minimum scale 64 that is compared against the scale of the current view to control the visibility of the layer.

In the example shown in FIG. 4, the feature count value may be less than 50, and hence, following the above example, the minimum scale may be 1:4,000,000. As the scale of the current view is 1:3,800,000, which exceeds the minimum scale, the zip code layer is turned on so that the zip code features 51 and associated labels are visible in the current view.

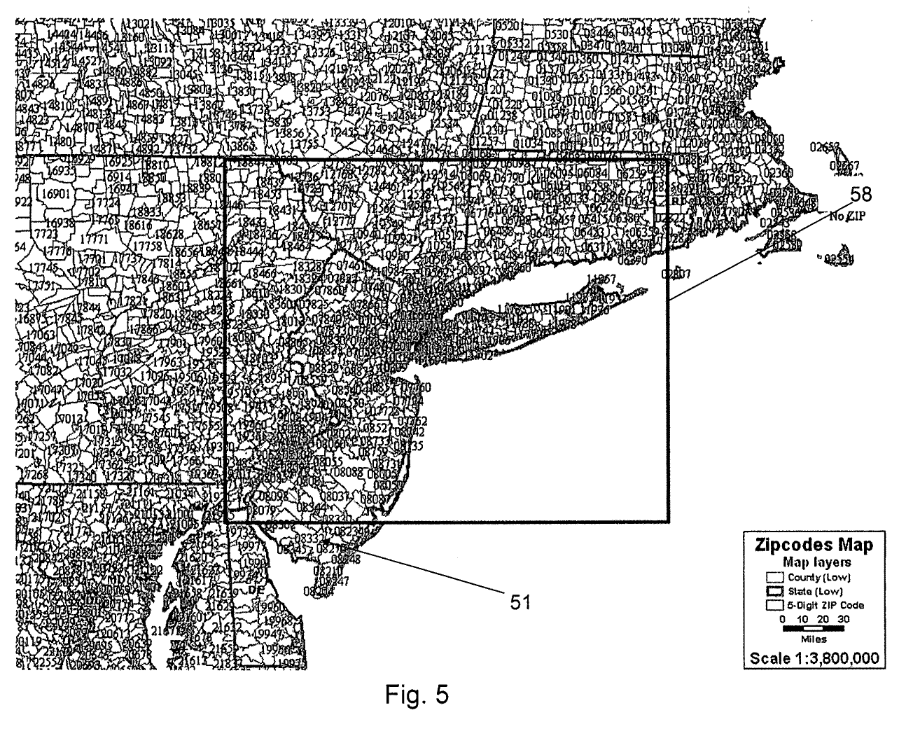

In contrast, if the user sets the pan of the current map view 58 so that a region near New York City is within the current map view 58, a different visibility result may be obtained. This is shown in FIG. 5, in which the zip code features 51 are densely packed, despite the same scale of 1:3,800,000 being used in the current view 58. In this example, the feature count value may exceed 100, and so a minimum scale of 1:2,000,000 should be used for optimum viewing, consistent with the example above. As the scale of the current view 58 is 1:3,800,000 and thus less than this minimum scale, the layer for the zip code features 51 would be turned off, and so the zip code features 51 and related labels would not be visible in the current view 51 (although, to aid in illustrating this point, they are shown in FIG. 5).

Data not present within the map database 30, but which may be related to the map database 30, may also be used to control the visibility of a layer. Data 32 that may be related to the map database 30 will include data that is capable of being mapped to locations within the region defined by the map database 30. That is, such mappable data may be of a type that contains information that is associated with position, geographical location or a feature, and hence may assign, for example, a value to a world coordinate or sub-region within the region defined by map database 30. Because of the transformations that map a world coordinate to a display 26 coordinate, discussed earlier, any information that is mappable to a world coordinate or sub-region within the map database 30 is similarly mappable to a point or region on the display 26. To illustrate this point, census data indicating the local populations within a greater region may be used. Related database 32, for example, may contain census data indicating the number of people within each feature or sub-region contained within the region defined by map database 30. Consequently, this information 32 may similarly be mapped to the current view 58 and used to establish a final visibility value to control the visibility of a layer. For example, the census database 32 may be used to establish the number of people within the current view 58. This count value may then be used to control the visibility of a layer associated with the related database 32, such as by comparing to a threshold value 65, a range of values 66 or by indexing into a suitable lookup table 60 to obtain a corresponding minimum scale. Such a system may provide satisfactory visual results as many features within the map database 30 are strongly correlated with population, such as zip codes, roads, census tracts, etc. Hence, the visibility of a zip code layer, for example, may be controlled by the population count or population density within the current view 58 as established by related database 32.

Because calculating the final visibility value for all features or mappable data within the current view may take a relatively large amount of computing resources, and thus induce delays when updating the display 26, in some embodiments pre-processing is first performed across a grid to establish visibility values for each element within the grid. The final visibility value is then calculated as a function of the visibility values of the grid elements within the current view. For certain specific embodiments, these steps may include: (1) creating a grid; and (2) using the grid to determine whether a particular layer should be visible in the given map view.

Step (1) may include: (a) defining the grid, using, for example, any standard global information system (GIS) function; (b) optionally clipping the grid feature data to an area layer of interest, which may be performed at a relatively low resolution; and (c) computing a respective visibility value for each grid element. In some embodiments, step (c) may include the steps of: (i) allocating a population to each of the grid elements; and (ii) computing the visibility value for each grid element using the respective allocated population and area of the grid element. In other embodiments, step (c) may include: (i) counting the number of features or feature vertices within each grid element of a control layer; and (ii) computing visibility value for each grid element using the respective count value and optionally the area of the grid element. In preferred embodiments, the control layer is a layer different from the layer whose visibility is to be controlled, but which has a correlation with the layer whose visibility is to be controlled. However, in other embodiments the control layer may be the same as the layer whose visibility is to be controlled.

Step (2) may include: (a) utilizing the values calculated individually for each grid element in step (1), calculating as the final visibility value the average visibility value for grid elements within the current map view; (b) determining the visibility of a layer using the final visibility value. In some embodiments step (b) may include: (i) selecting an optimal scale based on map view final visibility value; and (ii) determining the visibility of a layer based on the current view scale and the optimal scale selected in step (i). In other embodiments step (b) may include comparing final visibility value to a user defined range of values, for which, if within range the layer is turned on, otherwise the layer is turned off.

Each of the above steps and sub-steps shall now be described with specific reference to certain exemplary embodiments. It will be understood, however, that other variations are possible, and the examples provided are simply those thought to be particularly beneficial in understanding the claimed invention.

In the following embodiment, for step (1) above, an n n visibility grid is employed, with “n” being ten in units of miles, though, of course, other units may be employed. That is, a grid composed of a regular spacing of 10 10 mile squares is superimposed on the region encoded within the map data 30. Use of a regular visibility grid is not absolutely necessary. Indeed, the grid may be of any desired shape composed of a plurality of sub-sections. For example, a grid composed of county polygons, administrative polygons or the like could be used. In such cases, the visibility grid itself may be found within the map database 30. In other cases, the visibility grid may be an externally-defined function, as in the instant case of n n squares. A simple grid of n n mile squares has the benefits of low complexity (fewer coordinates are needed to define the grid), much lower than other geographies, such as counties, which have many more vertices. The 10 10 mile grid takes up little memory and is fast to query. The visibility grid, regardless of its shape, need not be visible to the user; its primary purpose is to determine visibility values of the map view to select the best respective scales for the layers.

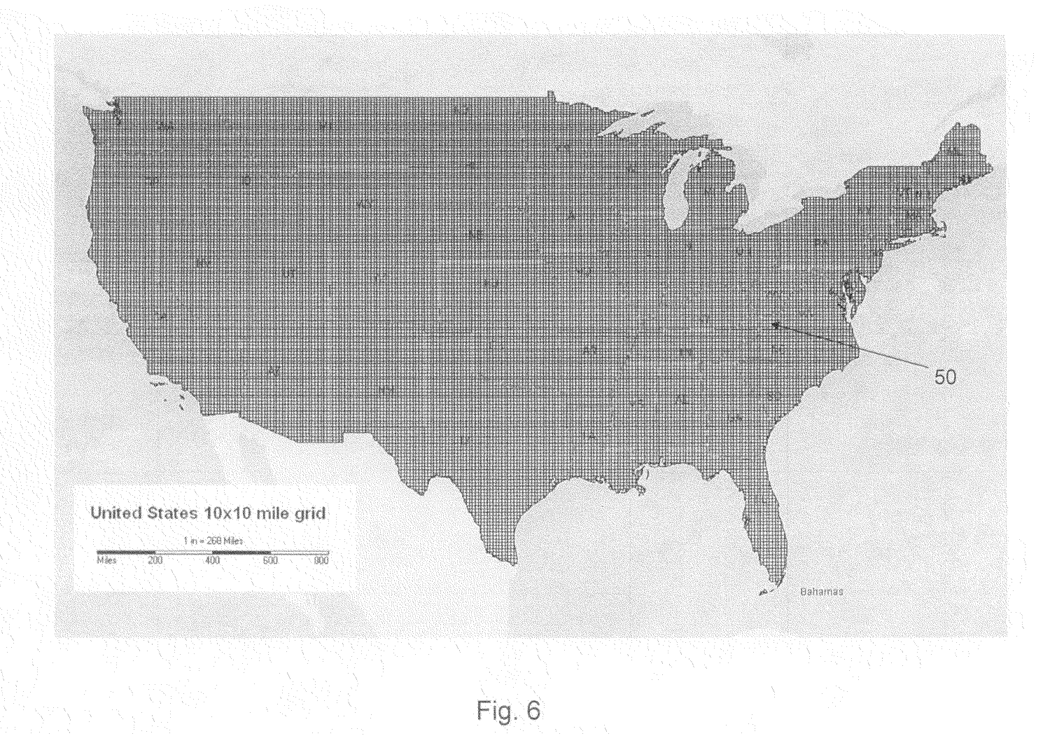

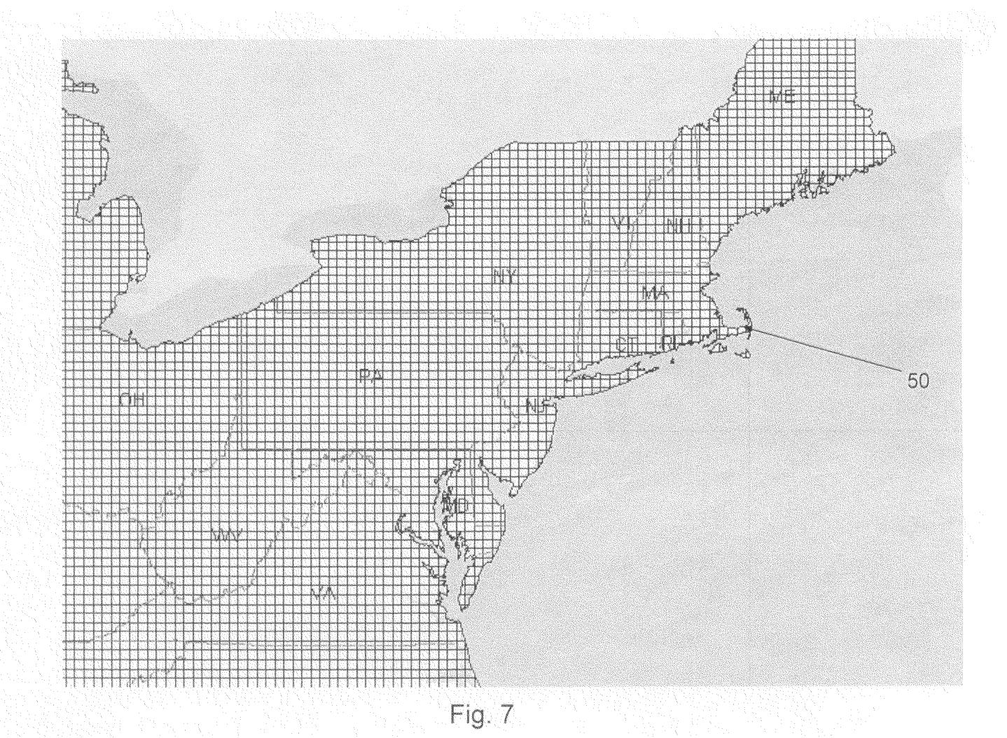

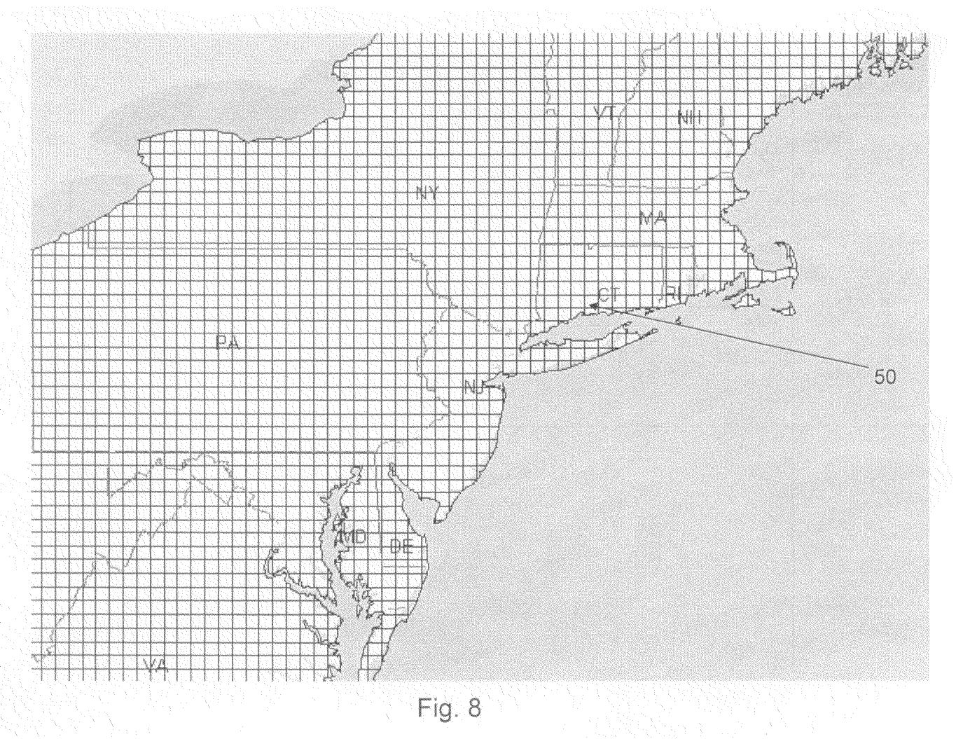

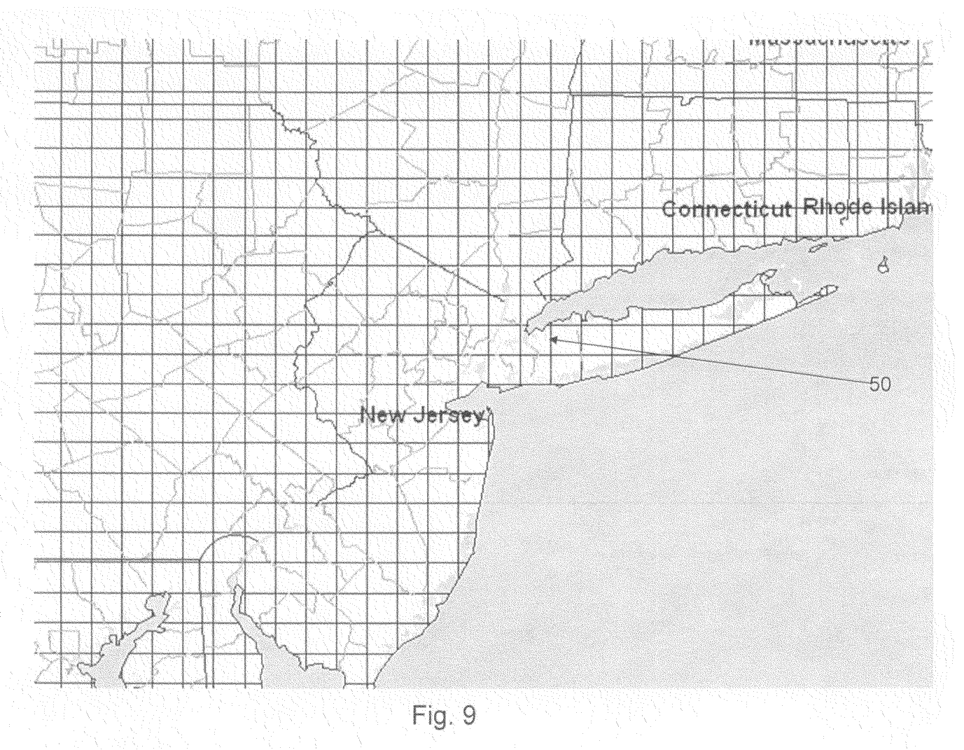

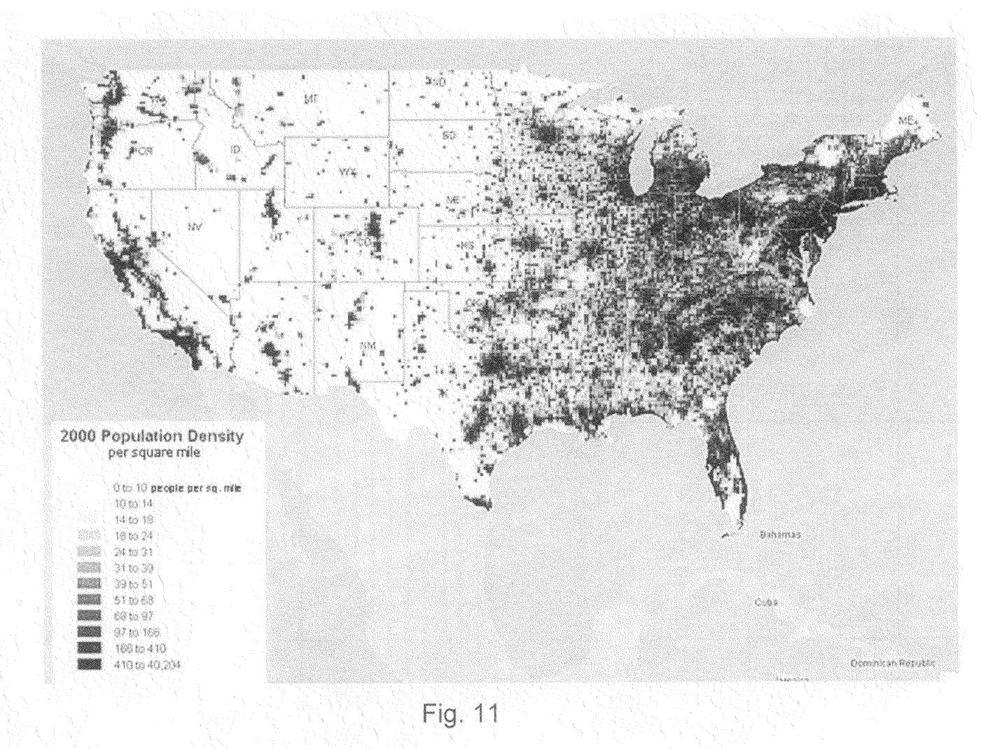

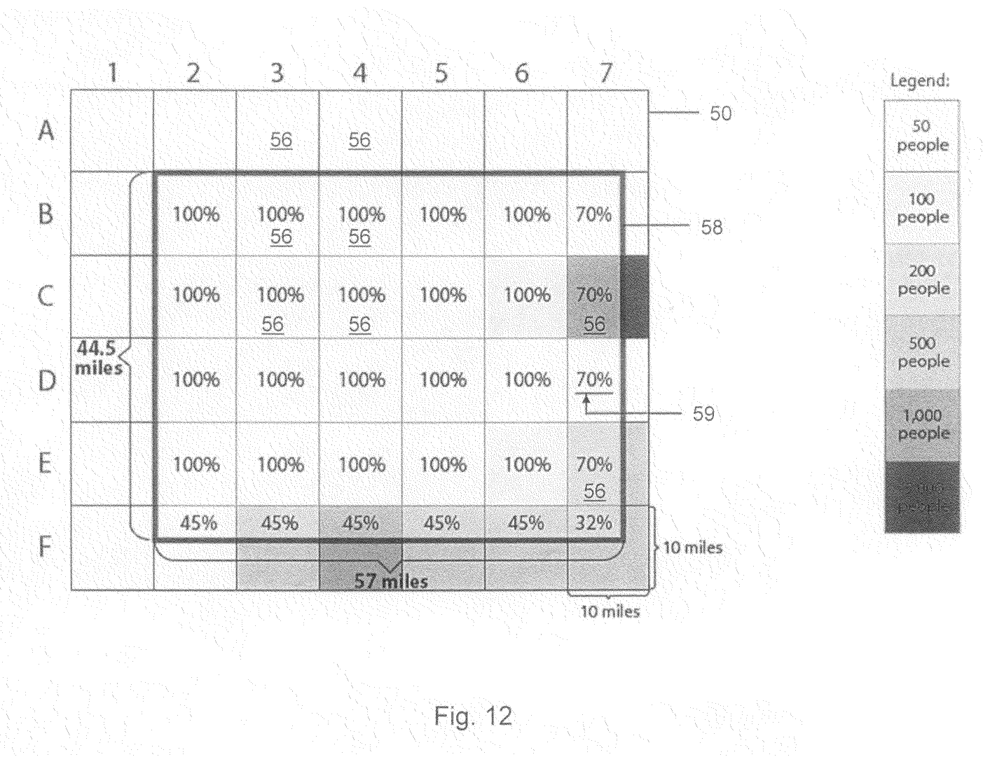

The first step, then, is to create a grid which is overlaid on top of the map as encoded within map database 30. In the examples and illustrations, United States geographies are used, but it will be understood that these procedures and techniques are applicable to any other vector-based geography. Please refer to FIGS. 6 to 10 for illustrations of a 10 10 mile grid for successively larger-scaled maps. In addition, FIG. 11 shows a U.S. population density map on a 10×10 mile grid.

A grid 50 may be created in a standard manner, such as by using a common GIS function available in many professional GIS packages, including Maptitude by Caliper Corporation, and Arc GIS by ESRI. For example, Caliper's Maptitude Version 4.6 may be used to create the 10 10 mile grid 50. The function is located under the menu selection Tools Geographic Utilities→Create Vector Grid. This GIS function is documented in the help system and on the web. In the following examples, the grid 50 is optionally clipped to a layer that defines the landmass extents of the United States. This means that along the coast and boundaries of the United States, the grid boundaries 52 are replaced by a generalized boundary (or coast) 54 of the United States. Those parts of the grid 50 that are not within the clipping layer (i.e., within the landmass of the U.S.) are clipped out. This step of clipping the visibility grid 50 is not required, but ensures more accurate results in subsequent steps when averaging of individual visibility values is performed across the grid 50, since a clipped grid 50 automatically removes from such consideration “uninteresting” areas that might otherwise skew the averaging results.

In this embodiment, a population is allocated to each element 56 in the clipped grid 50 using data from another related database 32, such as from a census tract or a census block group layer. Hence, the database 32 contains information that is mappable to the region defined in the map database 30. For example, with respect to census data, this may be done by determining the percent of area of each census tract (or the populated part of each tract at the block level) that is in a specific grid element 56 and then multiplying that population by the percentage. The resulting value is allocated to the grid element 56. This is a relatively well-known procedure called “area interpolation” and is supported in many GIS systems. The visibility value of each grid element 56 may then be calculated using the allocated population for the grid element 56. More preferably, the visibility value corresponds to a density of the population, and is calculated using the population allocated to the grid element 56 and the area of the grid element 56 (which may not always be square due to clipping), by dividing the population by the area. Hence, each grid element 56 may contain a corresponding count value (i.e., the population count in the grid element 56) or a density value (population density) for use as the visibility value.

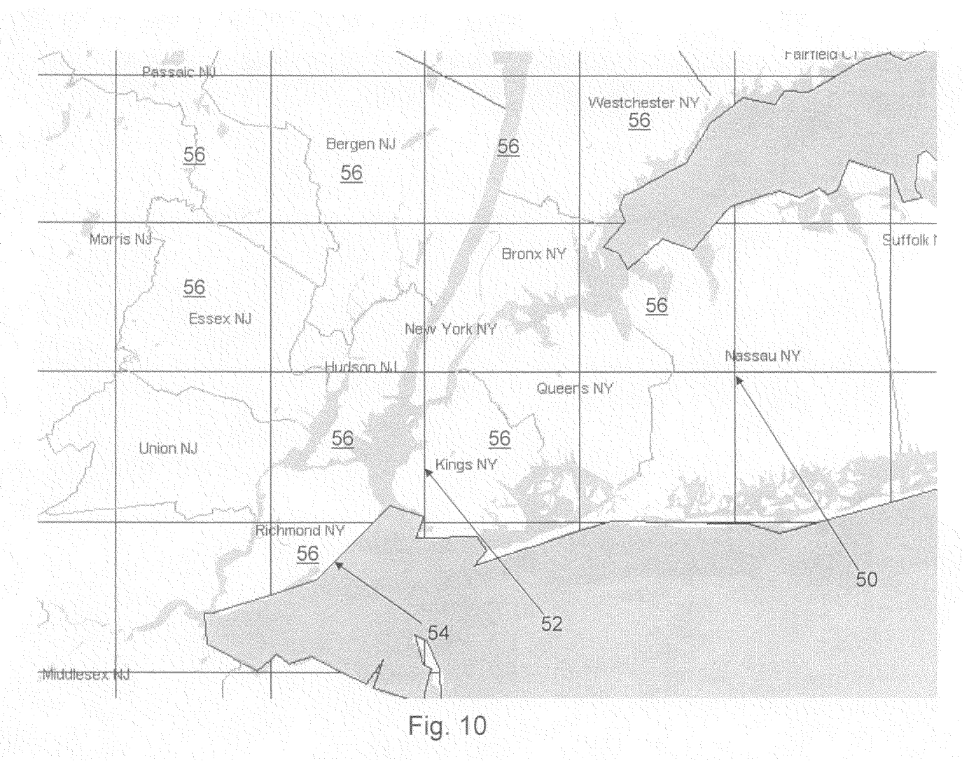

Step (2) above may then be performed. Generally, the visibility values of each grid element 56 within the current view may be used to calculate a final visibility value that is used to turn a layer on and off. For example, the average visibility value of the elements 56 within the current view may be taken, or a weighted average of the element 56 visibility values may be used to compute the final visibility value. Other functions are also possible, such as simply summing together all respective visibility values of the grid elements 56 in the current view. By way of example in the instant embodiment, to calculate the final visibility value for a given map view (that is, the current view), the population values of each element 56 within the current view may be added together and the resultant sum divided by the total pertinent area in the current view. The pertinent area in this example is land area. FIG. 10 shows an example of calculating the average population density in a map view, as indicated by current view lines 58. Grid elements 56 are “selected” by running a geographic query using the map view coordinates. Any grid element 56 within current view 58, completely or partially, is “selected” for processing. As shown in FIG. 10, grid features B2 to B7 by F2 to F7 would be in the selected set.

The map view 58, within which the average density calculation is performed to determine the final visibility value, covers 20 grid elements 56 at 100%, four elements 56 by 70%, five elements 56 by 45% and one element 56 by 32%. The area for the map view 58 may be calculated by adding up the respective areas of all selected grid elements 56 multiplied by the respective percent of coverage by the map view 58. With specific reference to FIG. 10, the area of the map view 58 may be calculated as (20*100)+(4*100*0.7)+(5*100*0.45)+(1*100*0.32)=2,537 square miles. The total population within the map view 58 may then be calculated as (18*50)+(2*100)+(2*50*0.7)+(1*5,000*0.7)+(1*500*0.7)+(1*50*0.45)+(3*500*0.45)+(1*1,000*0.45)+(1*500*0.32)=6,327.5 people. Consequently, the average density in the current map view 58 may be given as 6,327.5/2,537=2.5 people per square mile. This value may be used as the final visibility value that turns a layer on and off. For example, roads may be correlated to population densities, as previously discussed. Hence, the visibility of a road layer may be turned on and off using the final visibility value calculated from population information from the related database 32.

Alternatively, if the prior steps that calculated the individual visibility values of each grid element 56 had already calculated the population density for that grid element 56, then the final visibility value of the current view 58 could be calculated by the following: (A) for all grid elements 56 wholly or partially within the current view 58, do a summation of the respective population density (i.e., visibility value) in each element 56 multiplied by the percent of the grid element 56 that is within the current view 58; (B) do a summation of the area in each grid element 56 multiplied by the percent of the grid element 56 within the current view 58; and (C) divide the value obtained in step (A) by the value in step (B) to obtain the final visibility value.

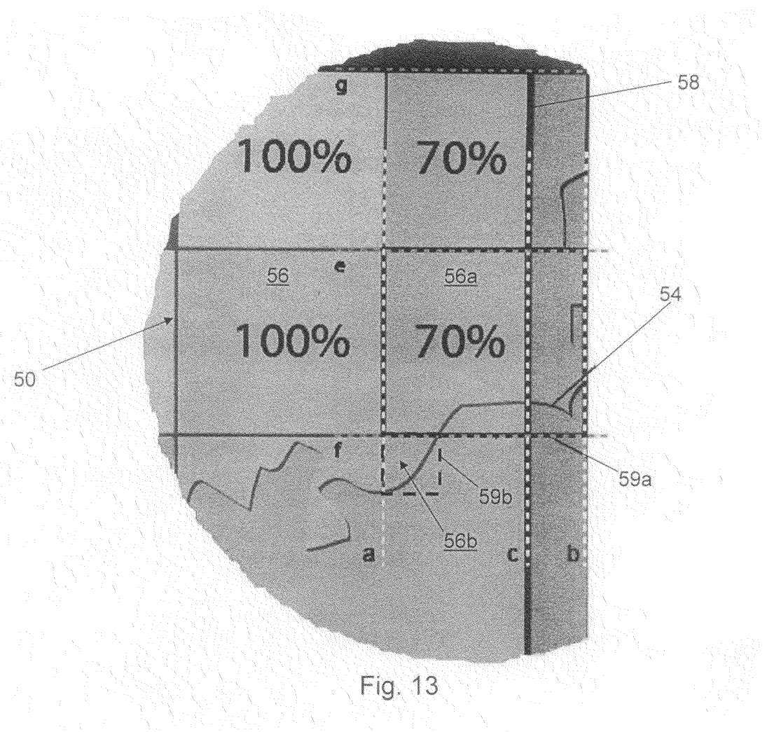

Reference is further drawn to FIG. 13, which provides a detailed view of a region within map view 58. For certain embodiments, it may be advantageous to employ a “bounding box” methodology when computing the area of a grid element 56. In such embodiments, for each element 56 a percentage is calculated that is within the map view 58 by using the “bounding box” 59 of the clipped feature of the grid 54. A bounding box is a box that fully encloses, or bounds, the clipped element 56. In this embodiment, for example, the clipped grid feature 54 may be the generalized geographical outline of the U.S. The reason a bounding box 59 is used is because clipping the grid 50 may create complex geographies along, for example, the coastlines. Using a bounding box 59 is an easy and fast way to approximately compute the area of an element 56 that is within the view 58. FIG. 12 shows an example of a complex coastline density computation. It is not important or necessary to be 100 percent precise in computing the density.

With specific reference to an element 56a shown in FIG. 13, the bounding box 59a is first determined that bounds all of the clipped regions 54 of the element 56a. The percent area of the element 56a that is within the map view 58 may then, with reference to items a through g in the figure, be calculated as follows:

If c>=b then xp=1; else xp=(c−a)/(b−a);

If g>=e then yp=1; else yp=(g−f)/(e−f);

Percent area=((c−a)*(e−f)*xp*yp)*100;

In the instant example for element 56a, the calculated percent area is 70%. Area for 56a is the full area of clipped element 56a multiplied by 0.70. Area of current view 58 is the sum of all areas of all grid elements 56 within the current view 58. Note, for example, that water areas are not part of this sum because they have been clipped from the grid 50. The area of the current view 58 may thus be more complex than simply view width multiplied by view height.

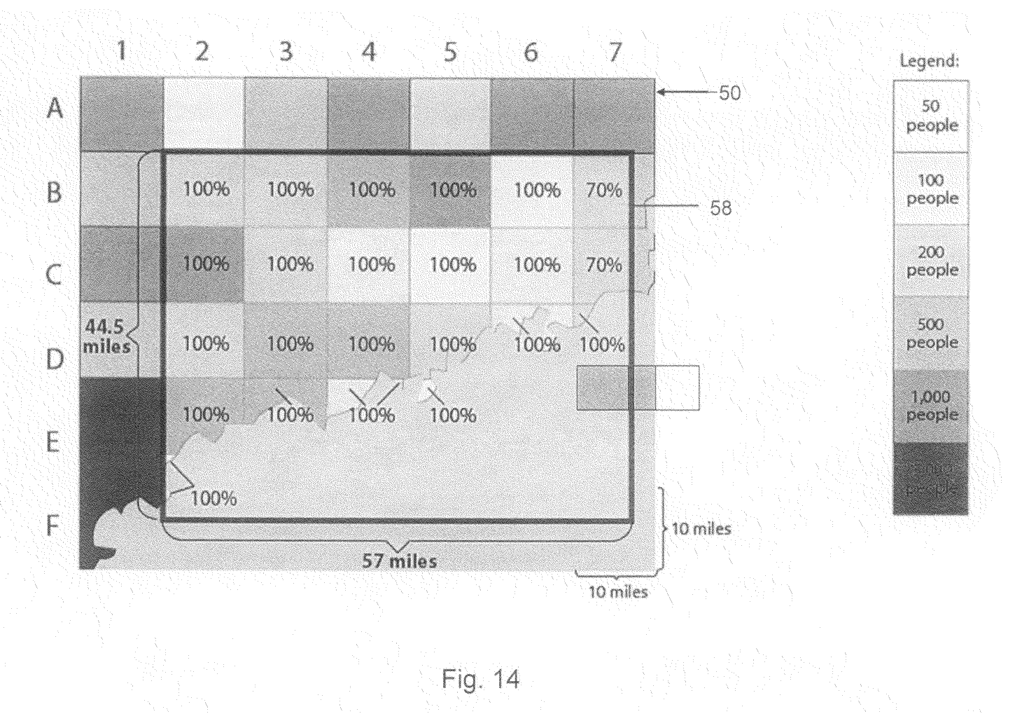

Once the relevant area of the map view 58 has been computed, the total population within the map view 58 can be computed by adding up portions of the population of each element 56 that lies within the map view 58. The third and final step is then to compute the density by dividing the total population by the total area computed in previous two steps. By way of example, attention is drawn to FIG. 14. FIG. 14 provides a larger view of percent areas, which includes the view shown in FIG. 11. As shown in FIG. 14, elements 56, clipped and unclipped that are wholly contained within view region 58 are given 100% areas. Elements 56 that extend outside the viewing region 58 have their respective areas reduced accordingly. The area for the map view 58 may be calculated as: (12*100)+(2*100*0.7)+98+60+30+10+7+25+35+75+10=1,690 square miles. The total population within the map view 58 may be calculated as: (2*5,000)+(5*1,000)+(6*500)+(4*200)+(4*100)+(2*500*0.7)=19,900 people. The feature density value for the corresponding layer within the map view 58 may thus be calculated as: 19,900/1,690=11.8 people per square mile.

Of course, as previously described, if the individual population densities or other visibility values have been fully pre-calculated for each of the grid elements 56, then computing the final visibility value may be as simple as performing an average of all the respective visibility values for each element 56 wholly are partially visible in the current view 58, with a suitable weighting provided to the visibility value of each element 56 based upon, for example, the percentage of that element 56 being contained within the current view 58, a predetermined weighting based upon position within the current view 58, combinations of the two, or other suitable functions.

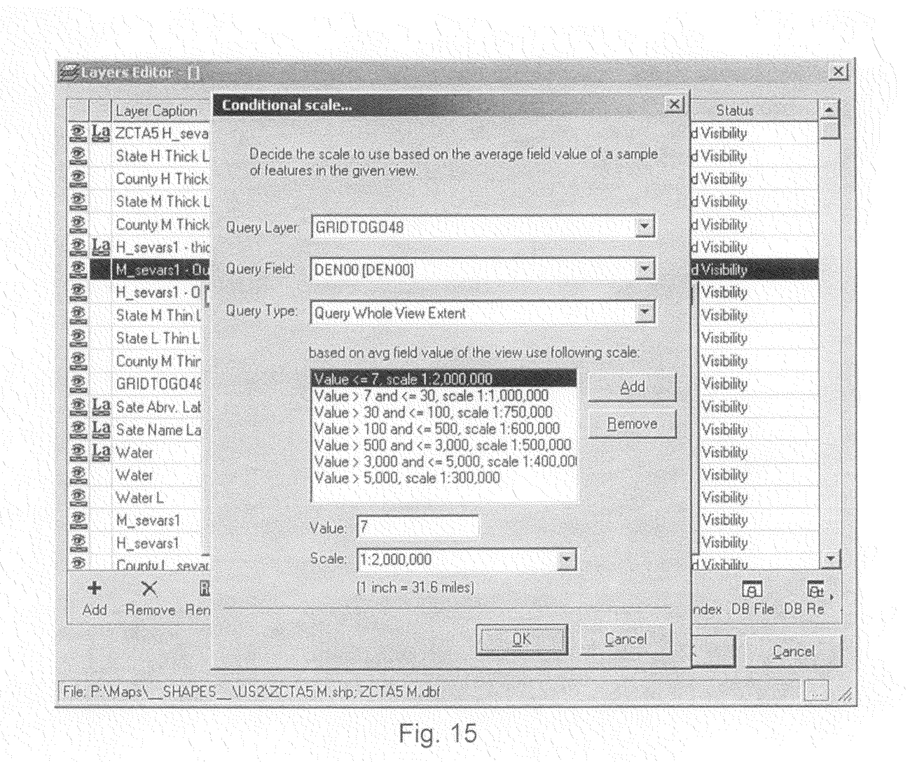

Using the computed density value, a set of optimal scales 60 (shown in FIG. 3) may be applied in determining the visibility of a layer. Standard input/output interfaces as known in the art may be used to generate, store and change the optimal scales 60, as indicated earlier. The mapping software 40 may include default scales 60, which a user may subsequently augment. FIG. 15 shows a dialog box with a list of scale values that has been found to work for many maps. Of course, other values for the scales 60 may be used, and tailored to provide the most pleasing display of the associated layer. By way of example, in FIG. 15 if a final visibility value is less than or equal to 7, a scale of 1:2,000,000 is selected for the corresponding layer. If the final visibility value is more than 7 but less than 30, a scale 1:1,000,000 is selected for the corresponding layer, and so forth. A set of scales 60 may be provided for each layer. Alternatively, a set of scales 60 may be configured for groups of layers. Indeed, a single set of scales 60 may be applied to all layers in the map. As indicated previously, the set of scales 60 may include one column for features and another column for text or labels to provide independent visibility control of text from features.

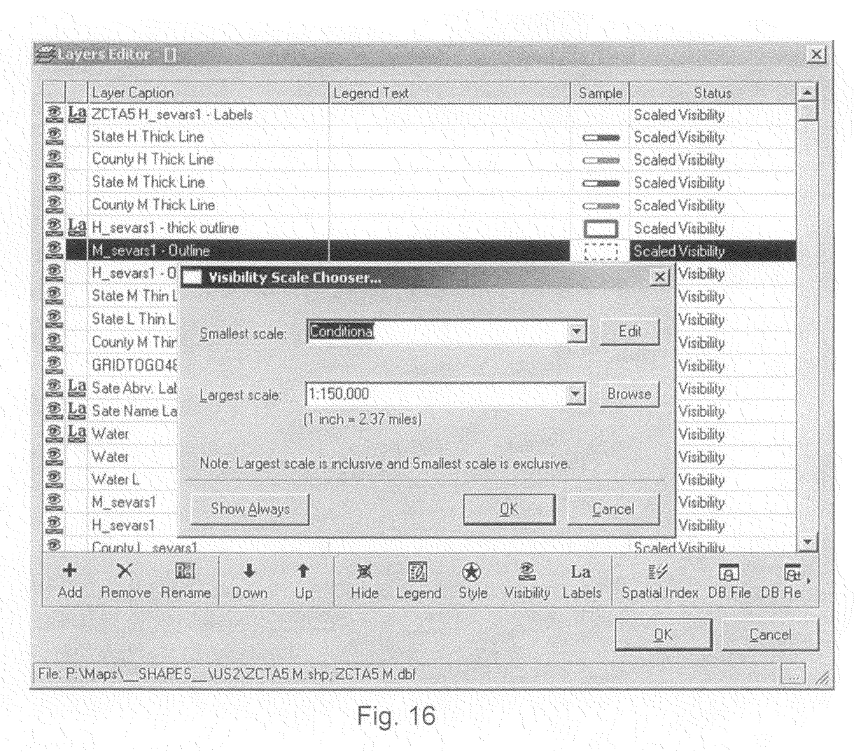

Deciding the visibility of features and text in a layer is then a matter of comparing the respective optimal scale value as provided by the lookup table 60 with the scale of the current map view 58. FIG. 16 shows a user interface that enables a user to choose if the visibility of a layer is to be conditional upon the computed final visibility value. The mapping software 40 may include conventional methods and algorithms for providing the user interface, or its equivalent, shown in FIG. 16. In the example shown, the smallest scale at which layer features continue to remain visible is set to be conditional upon the final visibility value, which may be computed from the features within the layer itself, such as from the density of the features. Additionally, the user may select the largest scale at which the layer features are always turned on, regardless of the density of the features. However, it should be clear that both smallest visible scale and largest visible scale can be “conditional” as computed by the adaptive method. For example, if the smallest scale for a layer is set to be “conditional,” then that layer features, text or both will be turned on if the current scale of the map view 58 is equal to or larger than the respective optimal minimum scale for the layer features/text, as indexed from the table of scales 60 by the computed feature density. The same may apply to the largest-scale. For largest scale, the layer features or text may disappear according to a respective conditional scale value selected by the final visibility value, analogous to the minimum scale values 62 in the lookup table 60. That is, an additional column or columns could be added to the table 60 that provides maximum scale values beyond which layer features, text or both would turn off. Alternatively, an entirely separate set of optimal scale values may be provided, one for optimal minimum scales and another for optimal maximum scales, each entry in each set having a corresponding final visibility value or final visibility value range.

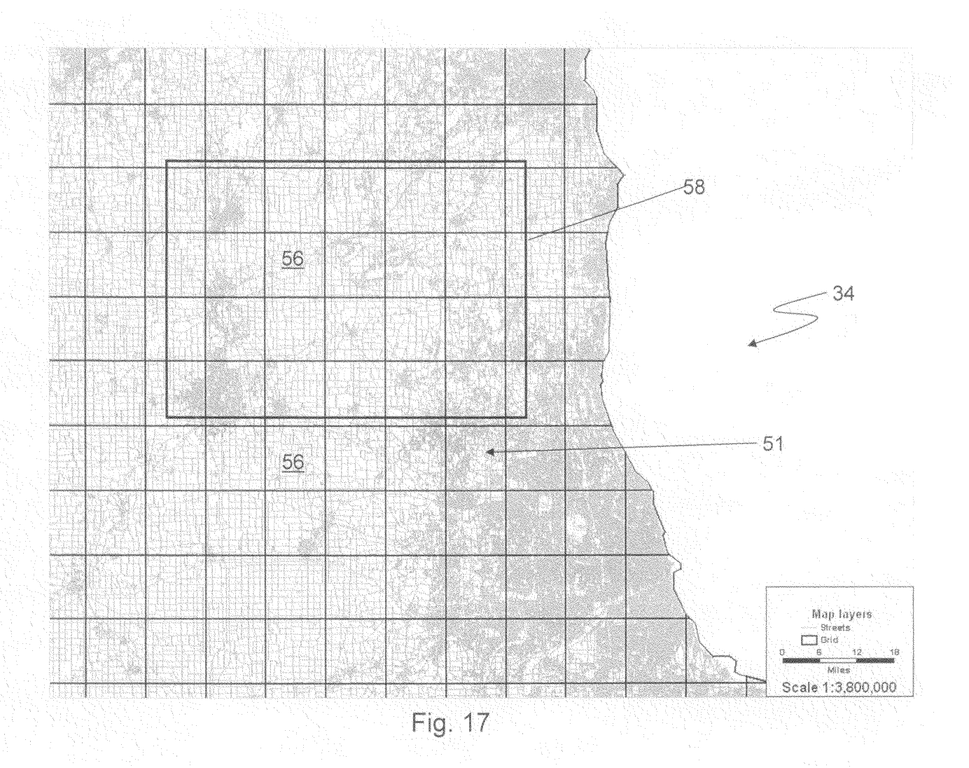

The final visibility value need not be a function simply of the count or density (i.e., value per unit area) of features or related data. Other functions may be employed to obtain a suitable final visibility count value, particularly functions that employ the map database 30 (such as features), related data 32, or combinations of the two. By way of a specific example, the total length of streets within the current view 58, or the average of such lengths for each grid element 56, may be used as a basis to establish the final visibility value. FIG. 17 shows a region 34 as encoded by map database 30, including as features 51 roads. A visibility grid 50 has been superimposed across the region 34, and has been clipped against another layer, such as the landmass of the region 34, leaving a plurality of elements 56 that may be square or irregular, depending upon the results of the clipping operation. Rectangle 58 shows the current view.

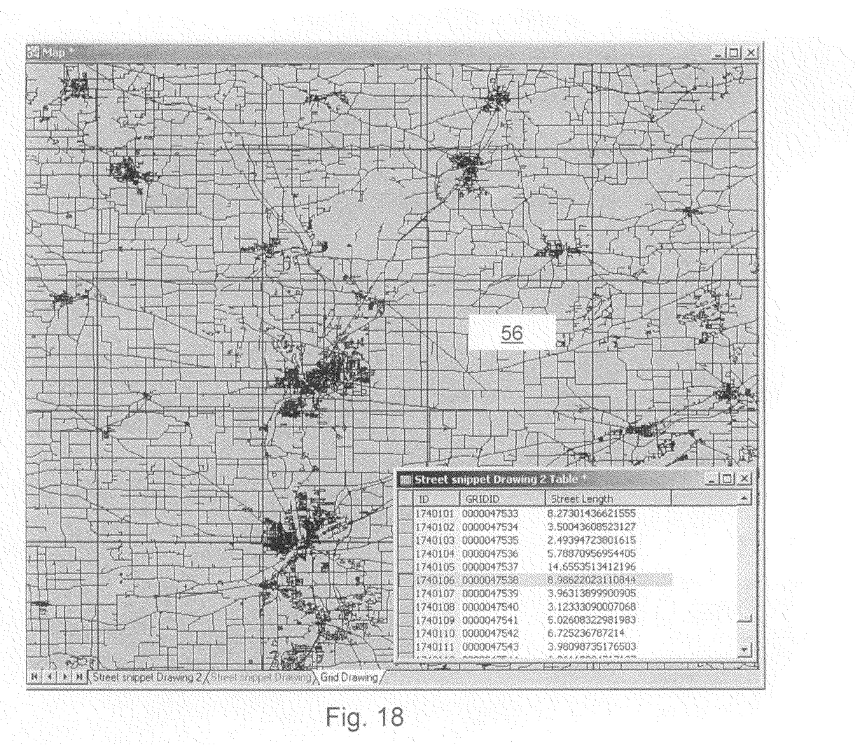

Pre-calculation of the respective visibility values in each grid element 56 may first be performed. To calculate the respective visibility value of each grid element 56, the total length of all the road features 51 in each element 56 is calculated, and this length is used as the visibility value for that element 56. Any suitable method may be used to calculate the total lengths of the road features 51. For example, with particular reference to the Manifold GIS System, version 6.5, the following steps may be performed. First, under the menu options open Tools→Options→Miscellaneous, the option “Set Transfer Rules for New Columns to Copy/Copy” is turned on. This makes sure that values for columns are set to copy/copy on transfer by default when geographies are split. The grid layer and the street layer are then imported into the Manifold system. A new map is created and these two layers are added to it. Topology Overlay is used to clip the street layer with the grid layer and at the same time transfer the grid element ID from the grid to each street segment, assigning that street segment to one of the grid elements. The street layer is then dissolved using the grid ID field to create one street record per grid element. The grid ID and street length are kept in the related database. The street database is merged into the grid layer using the grid ID as the matching field, to bring the street length into the grid, which provides the visibility values for the grid elements. FIG. 18 is a screen shot showing the association of street lengths with grid elements 56.

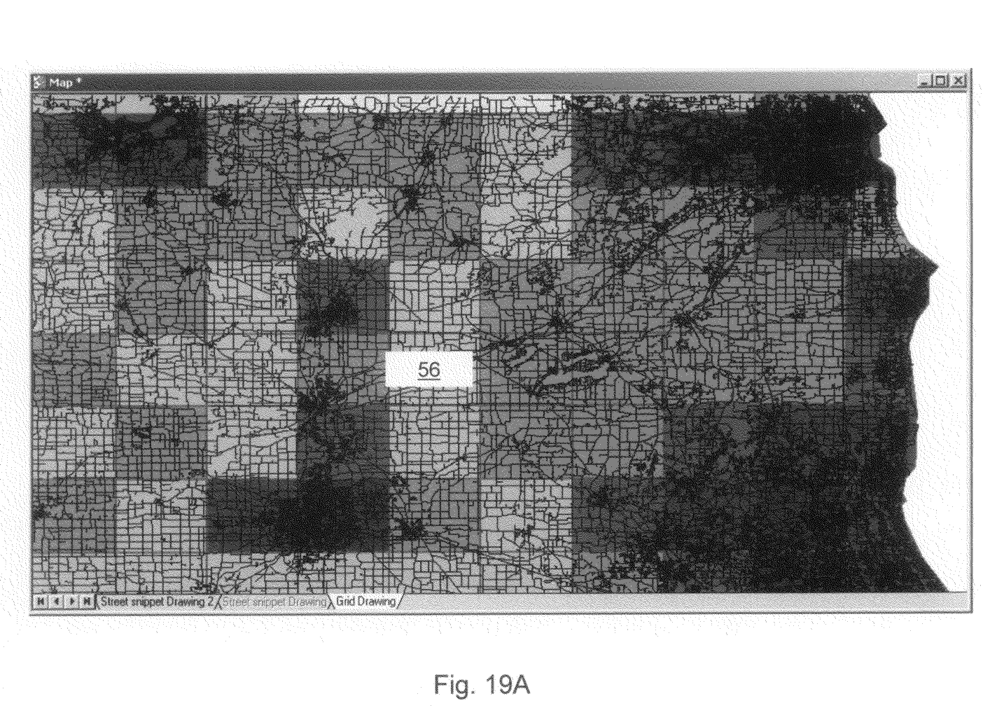

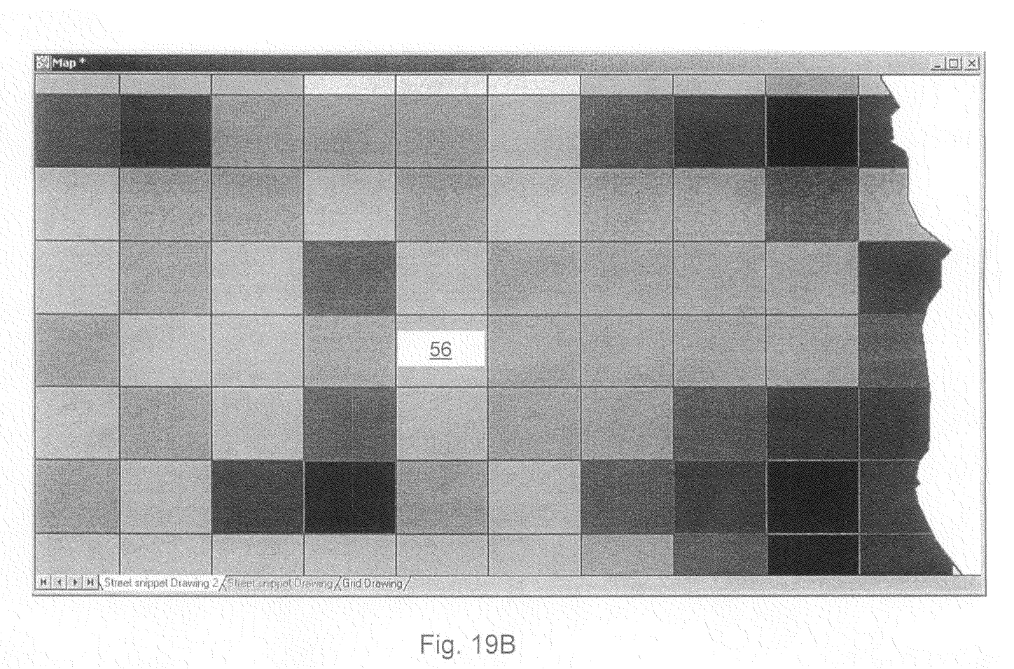

Of course, other methods may be used, and there is more than one way to do these operations. For example, the “Spatial Overlay” function maybe used to the same effect. Moreover, the operations used will necessarily depend upon the underlying mapping system used within the mapping software 30. Nevertheless, calculating the total length of the street features 51 within each grid element 56 is well within the means of one of ordinary skill in the art, as is providing suitable program code within the mapping software 30 to perform this function. FIGS. 19A and 19B provide color-coded results of the visibility value for each grid element 56. FIG. 19A shows the street features 51, and applies a background color to each grid element 56 based upon the lengths of the street features 51 within that element 56. FIG. 19B shows the same grid elements 56, but without the street features 51. As shown from the figures, the visual density of the street features 51 within each element 56 is closely related to the total length of the street features 51 within that element 56, and thus provides a good basis upon which to determine the visibility of the street layer, or even of another correlated layer.

Once pre-calculation of the respective visibility values for each grid element 56 has been performed, a relatively quick calculation to determine the final visibility value may be made based upon those grid elements 56 that are wholly within the current view 58, as well as optionally including into that calculation those elements 56 that are only partially within the current view 58. For example, the steps outlined above with respect to grid 50 visibility values being assigned based upon population may similarly be employed with respect to grid 50 visibility values being assigned based upon road length. It will further be appreciated that in other embodiments pre-calculation need not be performed, with the total street length within the current view 58 instead being recalculated each time the current view 58 is changed to obtain the final visibility value.

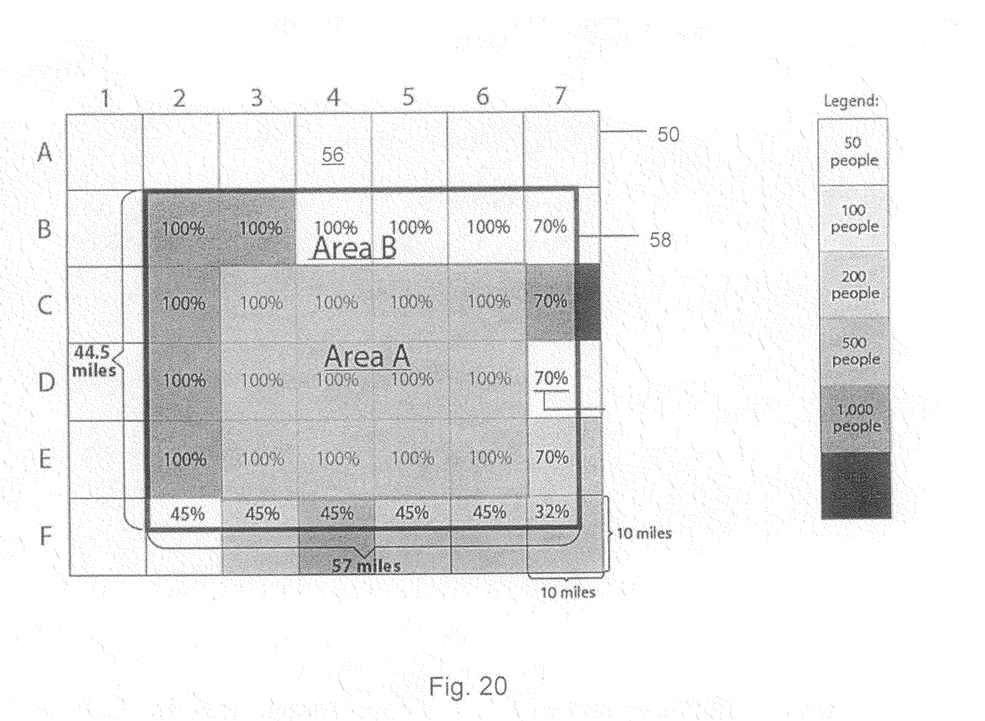

The above examples have used straight averaging techniques of the respective grid element 56 visibility values within the current view 58 to obtain the final visibility value, and used weighting to discount only those elements 56 not wholly within the current view 58. More complex techniques may, however, be employed that make use of the respective grid element 56 visibility values to determine the final visibility value. For example, what the user sees in the central area of the current view 58 of the displayed map is arguably more important than the peripheral area. Hence, one final visibility value calculation method may assign greater importance to the central area of the display 26 by using a weighing system. Indeed, certain embodiments may only take into consideration those elements 56 that are within the central area of the display 26 when deciding the final visibility value. The importance of elements 56 in the peripheral areas of the display 26 may be diminished by taking them only partially into consideration, or discarding them entirely from consideration. Any suitable function may be employed. For example, as shown in FIG. 20, two intermediate visibility values may be calculated. A first intermediate visibility value may be calculated based upon the visibility values of those grid elements 56 within a central area (“Area A”) of the current view 58 on the display 26, while a second intermediate visibility value may be calculated for the peripheral areas (“Area B”). Averaging techniques as performed above may be used to determine the first and second intermediate visibility values in their respective regions of the current view 58. The final visibility value may then be calculated as a function of the intermediate visibility values, such as by multiplying each of the intermediate visibility values by a respective weight and adding the results together. For example, a weight of 90% may be assigned to the first intermediate visibility value and a weight of 10% may be assigned to the second intermediate visibility value. As shown in FIG. 20, a final visibility value based upon unweighted element 56 visibility values (which employ population density as a visibility constraint) is 12.25 people per square mile. In contrast, if weighting is performed then the final visibility value may be calculated as ((700/1,600)*0.9)+(30,377.5/937)*0.1=3.64 people per square mile. Hence, the use of more complex functions in determining the final visibility value may significantly affect the display of layers in the current view 58.

Of course, relatively complex calculations for final visibility values are not limited only to those embodiments that employ visibility grids 50. Embodiments that perform direct calculation of features or related data in the current view may similarly employ such complex functions. For example, when counting features or related data, those features or related data within a central portion of the display 26 may be given more weight than other features or related data in the peripheral regions of the display 26. It will be appreciated then that any suitable function may thus be employed to develop the final visibility value. Most typically, however, this function will depend only on features within the current view, related data within the current view, or combinations of the two. Portions of the final visibility value may be pre-calculated, as with the above embodiments that make use of the visibility grids 50.

In other embodiments, however, another method may be employed to determine the final visibility value of the current view. In these embodiments, the region defined within the map database 30 is overlaid with a visibility grid 50 comprised of a plurality of grid elements 56 that enclose sub-regions within the region defined by the map database 30. One or more arbitrary values or absolute values are then assigned to each of these grid elements 56. In effect, a user, external database or both may assign individual visibility values to each grid element 56, rather than computing these values as is performed in the embodiments discussed above. A grid 50 composed in this manner may then be used as a basis for computing the final visibility value, using those elements 56 that are within the current view 58. Such embodiments give the map designer or user ultimate control over scale assignments.

All publications cited in the specification, both patent publications and non-patent publications are indicative of the level of skill of those skilled in the art to which this invention pertains. All these publications are herein fully incorporated by reference to the same extent as if each individual publication were specifically and individually indicated as being incorporated by reference.

Although the invention herein has been described with reference to particular embodiments, it is to be understood that these embodiments are merely illustrative of the principles and applications of the present invention. For example, it should be appreciated that the final visibility value need not be exclusively a function of features or data present in the current view, but may additionally make use of data or features not in the current view, or data that is not mappable to a region in the map database. It is therefore to be understood that numerous modifications may be made to the illustrative embodiments and that other arrangements may be devised without departing from the spirit and scope of the present invention as defined by the following claims.

What is claimed is:

1. A method for controlling visibility of at least a portion of a layer on a display, the layer corresponding to a set of features to be displayed from a first database comprising feature data for a plurality of features in a region, the method comprising:
calculating a final visibility value that is a function of:
features in the first database that are at least partially in a current view of the display;
mappable data capable of being associated with a location or sub-region in the region, the mappable data being used being at least partially in the current view; or
combinations thereof; and
turning the features in the layer on or off according to the final visibility value of the current view.

2. The method of claim 1 wherein the final visibility value is a function exclusively of the features in the first database that are at least partially in the current view, the mappable data that is at least partially in the current view, or combinations thereof.

3. The method of claim 1 wherein calculating the final visibility value comprises counting the number of features in a layer that are at least partially in the current view, obtaining a count value from the mappable data that is at least partially in the current view, or a combination thereof.

4. The method of claim 3 wherein the final visibility value is a density of the features in the layer that are at least partially in the current view, a density of the mappable data that is at least partially in the current view, or combinations thereof.

5. The method of claim 1 wherein determining the final visibility value comprises:
defining a grid comprising a plurality of grid elements;
for each of at least a portion of the grid elements, utilizing the feature data, the mappable data or combinations thereof to determine a respective visibility value for that grid element;
determining which grid elements are at least partially visible within the current view; and
utilizing the corresponding visibility value of the at least partially visible grid elements to determine the final visibility value.

6. The method of claim 5 wherein determining the visibility value for each of the at least a portion of the grid elements comprises:
for each of the at least a portion of the grid elements, determining within the grid element a count value that is a feature count, a mappable data value, or a combination thereof; and
dividing the count value by a corresponding area of the grid element.

7. The method of claim 1 wherein turning at least a portion of the layer on or off according to the final visibility value comprises:
comparing the final visibility value to a threshold value or a range of values; and
turning the features associated with the layer on or off in response to the comparison.

8. The method of claim 1 wherein turning at least a portion of the layer on or off according to the final visibility value comprises:
utilizing the final visibility value to obtain a corresponding minimum scale; and
turning the features associated with the layer on if a scale of the current view is greater than the corresponding minimum scale.

9. The method of claim 8 further comprising:
providing a set of optimal scales that associates a plurality of predetermined visibility values with a plurality of minimum scale values; and
utilizing the final visibility value to index into the predetermined visibility values to obtain the corresponding minimum scale value as the corresponding minimum scale.

10. The method of claim 9 wherein the set of optimal scales further associates a plurality of predetermined visibility values with a plurality of maximum scale values, and turning at least a portion of the layer on or off according to the final visibility value further comprises:
utilizing the final visibility value to obtain a corresponding maximum scale; and
turning the features associated with the layer off if the scale of the current view is greater than the corresponding maximum scale.

11. The method of claim 1 wherein weighted values of the features, the mappable data or combinations thereof are used to compute the final visibility value.

12. The method of claim 1 wherein turning at least a portion of the layer on or off according to the final visibility value further comprises turning labels or text associated with the layer on or off according to the final visibility value of the current view.

13. A method for controlling visibility of a layer on a display, the layer corresponding to a set of features to be displayed from a first database comprising feature data for a plurality of features in a region, the method comprising:
defining a grid comprising a plurality of grid elements, the grid overlaying at least a portion of the region;
assigning a respective visibility value to each of at least a portion of the grid elements;
determining which grid elements are at least partially visible within a current view of the display;
utilizing the corresponding visibility values of the at least the partially visible grid elements to determine a final visibility value; and
turning the layer on or off according to the final visibility value.

14. A computer system comprising:
a central processing unit (CPU);
a display adapted to present visual information to a user and controllable by the CPU; and
a memory in communications with the CPU, the memory comprising a first database comprising feature data for a plurality of features in a region, and program code executable by the CPU to perform the following steps:
calculating a final visibility value that is a function of:
features in the first database that are at least partially in a current view of the display;
mappable data capable of being associated with a location or sub-region in the region, the mappable data being used being at least partially in the current view; or
combinations thereof; and
turning the layer on or off according to the final visibility value.

15. The system of claim 14 wherein the final visibility value is a function exclusively of the features in the first database that are at least partially in the current view, the mappable data that is at least partially in the current view, or combinations thereof.

16. The system of claim 14 wherein calculating the final visibility value comprises counting the number of features in a layer that are at least partially in the current view, obtaining a count value from the mappable data that is at least partially in the current view, or a combination thereof.

17. The system of claim 16 wherein the final visibility value is a density of the features in the layer that are at least partially in the current view, a density of the mappable data that is at least partially in the current view, or combinations thereof.

18. The system of claim 17 wherein determining the final visibility value comprises:
defining a grid comprising a plurality of grid elements;
for each of at least a portion of the grid elements, utilizing the feature data, the mappable data or combinations thereof to determine a respective visibility value for that grid element;
determining which grid elements are at least partially visible within the current view; and
utilizing the corresponding visibility values of the at least partially visible grid elements to determine the final visibility value.

19. The system of claim 18 wherein determining the visibility value for each of the at least a portion of the grid elements comprises:
for each of the at least a portion of the grid elements, determining within the grid element a count value that is a feature count, a mappable data value, or a combination thereof, and
dividing the count value by a corresponding area of the grid element.

20. The system of claim 14 wherein turning the layer on or off according to the final visibility value comprises:
comparing the final visibility value to a threshold value; and
turning the layer on or off in response to the comparison.

21. The system of claim 14 wherein turning the layer on or off according to the final visibility value comprises:
utilizing the final visibility value to obtain a corresponding minimum scale; and
turning the layer on if a scale of the current view is greater than the corresponding minimum scale.

22. The system of claim 21 wherein turning the layer on or off according to the final visibility value further comprises:
utilizing the final visibility value to obtain a corresponding maximum scale; and
turning the layer off if the scale of the current view is greater than the corresponding maximum scale.

23. The system of claim 21 wherein the memory further comprises a set of optimal scales that associates a plurality of predetermined visibility values with a corresponding plurality of minimum scale values, and the program code further comprises steps for utilizing the final visibility value of the current view to index into the predetermined visibility values to obtain the corresponding minimum scale value as the corresponding minimum scale.

24. The system of claim 14 wherein weighted values of the features, the mappable data or combinations thereof are used to compute the final visibility value.

25. The system of claim 14 wherein turning at least a portion of the layer on or off according to the final visibility value further comprises turning labels or text associated with the layer on or off according to the final visibility value of the current view.
